(19) United States
(12) Patent Application Publication
(10) Pub. No.: US 2007/0109567 A1
(43) Pub. Date: May 17, 2007

(54) Reflective additive-primary kinematic color generators

(76) Inventor: Ralph Sloan Wilson JR., New Haven, CT (US)

Correspondence Address: R. SLOAN WILSON, 1140 CHAPEL ST, NEW HAVEN, CT, 06511, US

(21) Appl. No.: 11/274,833

(22) Filed: Nov. 14, 2005

(51) Int. Cl. G06F 15/00

(52) U.S. Cl. 358/1.9

(57) ABSTRACT

The process underlies a set of three-dimensional structures which may also find utility in the studies of vision science, geometry and physics. The apparent luminance of mixtures of diffusely-reflected additive primaries (RGB) is altered by the introduction of zero (or low) light intervals. In one type of structure the intervals of darkness lie between colored regions as opaque pigments on essentially openwork structures. In a second type, the intervals of darkness are integrated between rapid successions of colored regions. In a third type the intervals of darkness are also integrated between rapid successions of colored regions but the domains of the primaries are first configured as openwork structures. When viewed under incidental white light, the objects exhibit additive primaries by diffuse reflection to stimulate sensations of secondary colors—magenta, cyan, and yellow—and tertiary colors.

This application claims the benefit of U.S. Provisional Application No.60/60/627,140, filed Nov. 15, 2004; and U.S. Provisional Application No. 60/699810, filed Jul. 17, 2005, and will hopefully be reconnected with its related applications.

### BACKGROUND

By manipulating the luminosity function involved in color perception, the presented process (hereafter called the ‘Process’) links the additive-color system normally associated with emissive light, to the subtractive-color system normally associated with diffusely-reflected tight

Given that a single swatch of opaque reflected color (pigment and paint of all varieties) seems brighter when placed against a black background, the author observed that the perceived mixture of two superposed arrays of color, each of a different diffusely-reflected additive-primary red (R), green (G), or blue (B) also seems brighter when superposed with an array of black, or zero retinal stimulation.

The Process introduces intervals of black into otherwise low-level color stimuli arriving from RGB primaries diffusely reflected under incidental white light for the purpose of elevating the perceived luminance of the primaries to a degree that their mixtures, the secondary and tertiary colors, are also elevated. The modulation of intervals of zero light stimuli which seems to raise the perceived value of the additively generated combinations is one of the essential differences between this process and the prior art. Further investigations invited other differences which underlie the chromatics of three types of polychrome sculpture the author has created. The Process may also be helpful to the educational and scientific communities and may be utilized commercially to add novelty or intrigue to various products.

The Kinematic Color Generator is characterized by rapid movement of openwork structures which occupy two or three dimensions. The chromatic change is modulated by a static system of lines or points of RGB which is then rotated through only two dimensions. The integration of black occurs either through spaces between the colored elements, or located adjacent to, and moving with, the colored elements.

### Background for the Kinematic Color Generators

Aside from what ahs been decrinbed in my the parent applications, The Kinematic Color Generators employ a simple graphic system which permits the Process to be expressed in a strictly two dimensional rotation without creating a whitish or greyish blur of all three RGB primaries. Since it is easy to apply this system onto discs (or three-dimensional surfaces), traditional spinning tops might be one of the simplest manifestations.

Most spinning tops create concentric blurs of their stationary images because they rotate at thousands of revolutions per minute. The image discernible in their stationary phases is no longer discernible while rotating and any new concentric pattern formed while rotating shows no clear organization of color or new color. There is a tendency is to fill the entire visible area with many colors and the spinning effects are usually a let down. To avoid this dull result, pigments are frequently applied to tops as concentric circles, but once spinning there is no change—the color in any given circumference is the same in both phases. A pattern of colors, where circles are composed of two colors will produce blurred combinations of colors, but the stationary image is already circular. A staggered pattem where colors also occupy neighboring circumferences, such as rings of interleaved elements, is also essentially circular in both phases. Furthermore, the additive color process is not taken into account. The graphic system of Type III resolves the problem by translates the Process as elliptical openwork structures (some of them resembling atoms as commonly symbolized), to produce in the rotating phase discernible multi-colored concentric rings (some resembling atomic spectra).

There are perhaps billions of spinning tops in the world, and perhaps billions with colors. To search them all is impossible. However, the novelty of the Kinematic Color Generators suggests to the applicant that if this system were already known, it would continue to be exploited, and by probability alone, he would have seen an example by now. He has not.

The prior art seems to differ from applications of the Process in the following ways:

The known kinetic devices rotating in two-dimensions are, a) reflective with subtractive-primaries; b) reflective with additive-primaries but without dark function, c) emissive but do not employ the emissive or transmissive equivalents of the graphic systems in Type III.

The known static devices are, a) diffusely reflective employing to some degree RGB primaries and dark elements but are two dimensional, b) three-dimensional but do not employ additive primaries, c) three-dimensional with additive primaries but not reflected under incidental white light.

The following true/false table lays out the differences of which the applicant is aware.

| | diffuse reflection | | | color change |
|---|---|---|---|---|
| catagory | under | RGB | dark | effected by |
| of prior art | white light | primaries | function | reorientation |
| textiles | T | T | T | F |
| paintings | T | T | possible | F |
| 3-D | T | T | F | F |
| rotational | T | T | F | F |
| top-like | T | F | T | T |
| electronic | F | T | T | T |
| Process | T | T | T | T |

Other references include U.S. patent Ser. No. 02/184,125, Patterson, 1939; U.S. patent Ser. No. 03/474,546, Wedlake, 1969; U.S. patent Ser. No. 05/310,183, Glikman, 1994; U.S. patent Ser. No. 05/634,795, Davies, 1997; U.S. patent Ser. No. 06/050,566, Shameson, 1998; U.S. patent Ser. No. 02/583,275, Olson, 1949; U.S. patent Ser. No. 02/332,507, Dailey, 1943; U.S. patent Ser. No. 00/547,764, Boyum, 1895; and the work of artists Lucas Samaras, and Sol LeWitt, and Ellsworth Kelly.
¹ Dowling, The Retina, 1987; Livingstone, Vision and Art, 2002; Gergenfurtener and Sharpe, Color Vision, 1999; see chapter 7 of Dowling for general information on dark adaptation and cellular dark-responses.
²Livingstone, Vision and Art, 2002
³ibid.

### BRIEF DESCRIPTION OF THE INVENTION

The invention underlies a set of three-dimensional art objects which may also find utility in the studies of vision science, geometry and physics. The apparent luminance of diffusely-reflected additive system primaries (RGB) colors is altered by the introduction of zero (or low) light intervals. In Type III, intervals of darkness are integrated between rapid successions of colored regions but the domains of the primaries are first configured as openwork structures or graphics. When viewed under incidental light, the objects exhibit additive primaries by diffuse reflection to stimulate sensations of secondary colors—magenta, cyan, and yellow—and tertiary colors. Again, the primaries exhibited from these objects are those primary colors associated with the additive system, (namely blue, green, red), but are diffusely-reflective, not illuminants. The objects may be viewed together or independently. The primaries, blue, green, and red, labelled B, G, or R in the figures and text, are detailed at the end of the specification.

### BRIEF DESCRIPTION OF THE DRAWINGS

FIG. 1 shows rosettes composed of a unit ellipse repeated about the focus, each rosette exhibiting one primary of either red [R], green [G], or blue [B]. In FIG. 11, ellipses of each rosette has one of its foci in common.

FIG. 2 also relates to Type III ellipses. The nested rosettes of ellipses each rosette being either red [R], green [G], or blue [B], are centered on their axes of symmetry.

FIG. 3 Elemental ellipses, in either red [R], green [G], or blue [B], of a thicker ellipse are fanned out, each at 36°.

FIG. 4 shows single ellipses, red [R], green [G], or blue [B].

FIG. 5 shows another variety where the lines are cut short by the edge of the disc, and

FIG. 6 shows a simulation of what the Type III generator of FIG. 15 color bands look like when spinning

FIGS. 7 and 8 show lattices described in the text.

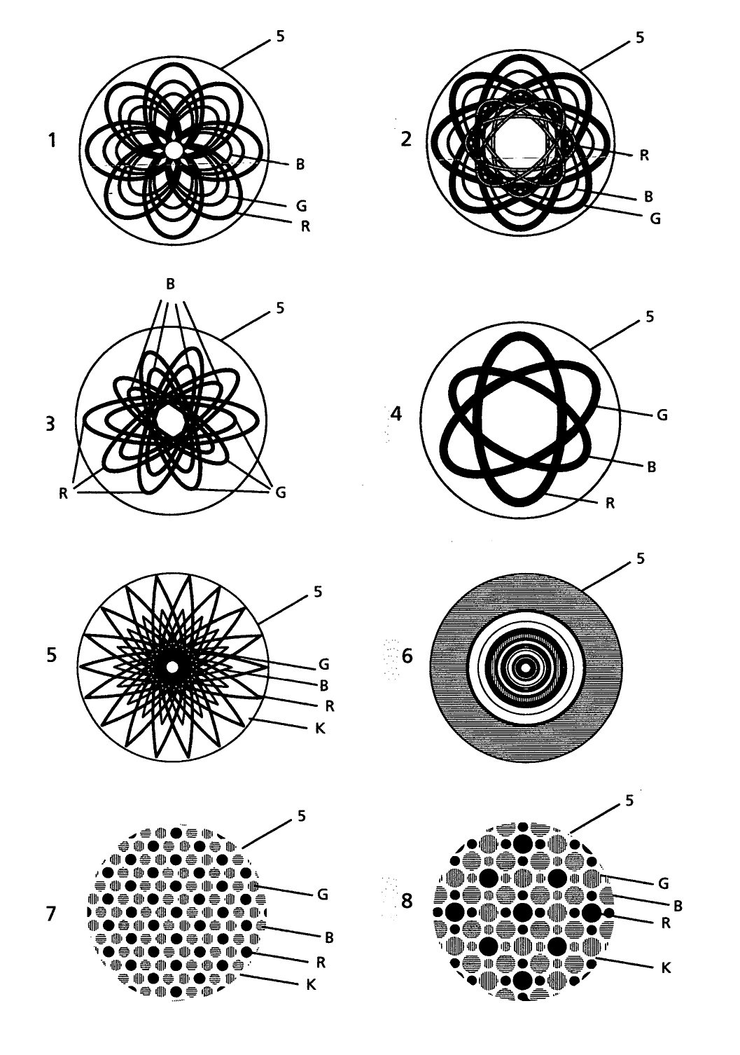

### DETAILED DESCRIPTION OF THE INVENTION

Kinematic Color Generator (Type III)

As previously stated The Kinematic Color Generator is a synthesis of more or less static openwork structures and rotational structures described in another application, and is characterized by rapid movement of RGB openwork structures or openwork graphics. Here the chromatic change is modulated by rotating a static system of lines or points of RGB through two dimensions. The integration of black occurs beyond the colored elements through the spaces between them, or located adjacent to, and moving with, the colored elements.

Flattened Varieties

The three-dimensions of Type I can be flattened if there is reasonable means to apportion the primaries into ratios other than 1:1:1. A two-dimensional surface rotating in the very same two dimensions affords no other direction for apportioning the color domains but radially inward or outward, otherwise all three colors will end up in the same arc of rotation and be a grayish white. One can apportion the colors like a pie as Newton did but the whole disc will generate the same color.

This generator has a visible two-dimensional surface capable of rotation about an axis 90° to the surface's extension in those dimensions and does not involve precession or change in angle as part of its operation. Instead, ellipses observed when viewing a circular disc in precession or in the motion of the top described in part II, have been translated as nested rosettes of linear ellipses fixed to the plane of a disk (or platform suitable for spinning). The rosettes may vary according to the focus, shape, size, line-widths of ellipses, and the number of unit ellipses per rosette. The lines of each rosette intersect according to the number of repetitions of the unit ellipse per arc and the difference in length between the unit ellipse's major and minor vertices.

While rosettes of ellipses (and similar geometric figures, including those with straight lines) are certainly not new, they may be original as expressed here with diff-usely-reflective RGB primaries over black grounds—in some of the nested rosettes described here, secondary colors begin to appear in the stationary phase at short distances because the lines are very thin. This however, may not qualify as functionally distinct beyond the prior art and remains a two dimensional relative of the static openwork varieties describes in another application.

When the generators are spun, however, concentric bands of new colors appear as line-widths of the ellipses are summed through the arcs of rotation. The resulting quantity of color per concentric band is the sum of all the colored ellipse line-widths cut by the arc. The thickness of a uniform line-width with respect to the arc of rotation, increases with curvature of the ellipse. This system of ellipses in rotation against a dark field provides a way to include all three primaries on one surface and generate surprisingly clean unambiguous secondary colors and an extremely wide range of tertiary colors.

Not illustrated are these permutations: a) the system of nested ellipses as described above where each ellipse itself is divided into red, green, and blue segments, b) the same system of ellipses as described above where the ellipses are not solid lines but dotted lines. The same system of ellipses can be applied emissively by lighting additive primaries from behind, or even with LEDs (but if the disc is in the form of a spinning top, in the dark one can't see the top itself).

Many of the ellipse patterns can also be extrapolated as single lines representing the traced path of a point in an elliptical orbit which itself is in rotation. For the example in FIG. 13, the single line would be divided into three sections of the three primaries red green and blue.

The substrate of the surface [5] upon which the colored ellipses appear can be either opaque or clear. A black field [K] as indicated in illustration 1 through 8, is made to surround the colored ellipses. When the substrate is clear, the device can be spun in front differently colored grounds, or black or white, each of which effects the nature of the perceived colors on the spinning surface. Unlike the kinetic color generator, the elliptic generators can also be augmented with other primaries from the subtractive set, but the surprise upon spinning is diminished. The primaries on transparent subtrates may be transparent (filters) and from the subtractive set. But again, the more colors applied, the more the difference between stationary and rotating phases shrinks.

Some of the rosettes suggest a two-dimensional simile of an atom's electron's orbit as conceived by Rutherford and Bohr in the early days of atomic theory—the stationary phase being similar to the elliptic orbits, and the spinning stage similar to an atom's spectral signature.

Also pictured are lattices of opaque red, green, and blue dots. The grids of opaque additive-primaries cover a transparent disc, or are surrounded by a field of black pigment. Experiments with other shapes of grid elements were also tested.

Three-Dimensional Varieties

Many of the above Type III graphics can be used on the top entitled Kinetic Color Generator as described in section II, (including the saddle shape variety). All of the above kinds of ellipse patterns can be extrapolated in three dimensions as a stack of wire or die-cut rosettes. The two-dimensional projections can also be translated as a wire, or string of material, extending like a spring, into the axis of rotation.

Best Mode Contemplated

There are numerous possibilities of the Process and the extention of the process. From works of art, to educational devices and candy shelf novelties. I feel I have already described some of the best modes, here and in the previous application. I have contemplated and tested hundreds of possibilities of the the above described. These will work well as gyroscopes, maybe even hubcaps. A helix can be colored with the three primaries running lengthwise, inside and out. With its central axis in a circle forming a torus, it too can be balanced and rotated. Would candy-tops, entice children to learn a little more about color and photoreceptors? Since few adults could explain it either, one has to wonder if this would be a good mode.

### APPENDIX

Wavelengths of the Reflected Primaries

The additive primary red [R] indicated in this specification and the figures reflects wavelengths 570-650 nm with peak values near 620 nm. The additive primary green [G] indicated in this specification and the figures reflects wavelengths 500-650 nm and slight reflection toward the 400 nm range, with peak values near 550 nm*. The additive primary blue [B] indicated in this specification and the figures reflects wavelengths 400-700 nm with peak values near 440 nm. An alternative blue [B] reflects wavelengths 400-700 nm with two peak values, one near 440 nm and the second near 510 (there is a third curve at the very far end of the red near 700 but hard to notice with the naked eye).

Pigments and Pigment Compounds Used for the Invention

The primary pigment compounds can be made from a number of fundamental coloring agents. The author has obtained them using the following pigments: Ultramarine blue (PB 29); Cobalt blue (PB 28); Cadmium reds; Cadmium orange; Cadmium yellow; Napthol red light (PR 112 ); Irgazine red; Irgazine orange; Arylide yellow (PY 73 GX); Arylide yellow (PY 3); Phthalocyanine green (PG 7); Zinc white (PW); Titanium white (PW 6 ); Aluminum oxide. Fluorescent pigments were tested in 2003 but with lesser quality paints and the results were poor. They may have contained too much fluorescent white. But this can be remedied with better quality inks and paints or by adjusting the pigment load. Fluorescents are, to a degree, emissive, but because they are also diffusely reflective under incidental white light they help complete the continuity between purely reflective additive processes decribed here and the purely emissive.

Pigment Compounds for Blue

Ultramarine is exceedingly dark at full strength and needs some white added to bring the reflectance within range of the other two colors. Tinted ultramarine reflects wavelengths in a curve which peaks at about the same frequency as the absorption curve for the retinal receptor of blue light, which is about 425 nm.

Pigment Compounds for Green

Phthalocyanine green, a very bluish green, reflecting wavelengths in a curve that peaks at about 500 nm but stretches into the retina's green receptor range, can be mixed with yellow pigment to cancel the blue and leave most of the mixture in range of the green photoreceptor, which peaks at 530 nm. The desired green is a very yellow green similar to the color seen when looking up through a canopy of sunlit vegetation. Arylide yellow reflects wavelengths in a flat topped curve from 500 to 700 nm, which includes 530 and 560 nn where the absorption curves for two retinal photoreceptors peak for green and red, respectively. Reflecting only green and blue, the phthalo, absorbing most everything above 550 nm, absorbs the red of the arylide. Reflecting only red and green and absorbing everything below 500, the arylide absorbs all the blue of the phthalo. We are left with a green compound reflecting wavelengths in the green photoreceptor's range.

Pigment Compounds for Red

Napthol red, which should be a very warm red, can be applied straight. The retinal photoreceptor for the red light wavelength has a peak absorption rate at about 560 nm, and the bottom range of napthol is about 560 nm.

Alteration of Values

Aside from needing to be as bright and intense as possible, the values of all three primaries indicated above can be changed to some degree but it is important the relationship between values remains somewhat consonant. The blue pigments, in all cases of the specified invention have been modified with white, such that on a value scale from 1 to 10 where red is near 6, green near 5, then blue is near 4. Likewise, if the red and green are near 6 and 7, then the blue is near 5.

I claim:

1. A color-mixing process with pigments or dyes wherein three additive-primary colors and intervals of darkness are exhibited from the surface of an opaque three-dimensional structure under incidental light and ratios of said additive-primary colors and intervals of darkness are modulated by changes in said structure's orientation with respect to a human observer possessing normal color vision.

2. The color-mixing process of claim 1 wherein said structure is constructed as openwork.

3. The color-mixing process of claim 1 and 2 wherein the field surrounding said structure under incidental white light is reduced to near zero luminance.

4. A spinning top with a curved base and a shaft for spinning the top, wherein a disc of rigid material is fixed orthogonally between said base and shaft, said disc and said shaft possessing a mass and being of such proportion so as to relocate the center of mass of said top to a position located slightly above the radius of arc of said base.

5. The spinning top of claim 5, wherein a small repositionable weight is attached to the perimeter of said disc.

6. The color mixing process of claim 1 and the spinning top of claim 5 wherein said disc exhibits said three additive-primary colors.

7. The color-mixing process of claim 6 wherein the field surrounding said structure under incidental white light is reduced to near zero luminance.

8. The color-mixing process of claim 1 wherein said opaque structure has transparent elements and said additive-primary colors are opaque.

9. A graphic combinatory system for generating color wherein rosettes defined by lines are nested around a central axis and rotated in front of a black ground, said rosettes being of no more than three colors and said lines being variable in width, angle of curvature, and length.

10. Intructions on how to use the color-mixing process of claim 1.
